(19) United States
(12) Patent Application Publication
(10) Pub. No.: US 2024/0425779 A1
(43) Pub. Date: Dec. 26, 2024

(54) CLEANING PRODUCT

(71) Applicant: The Procter & Gamble Company, Cincinnati, OH (US)

(72) Inventors: Jean-Luc Philippe BETTIOL, ETTERBEEK (BE); Alice Michele BOUTOILLE, BRUSSELS (BE); Denis Alfred GONZALES, BRUSSELS (BE)

(21) Appl. No.: 18/744,880

(22) Filed: Jun. 17, 2024

(30) Foreign Application Priority Data
Jun. 20, 2023 (EP) 23180233.1
Dec. 13, 2023 (EP) 23216137.2

(51) Int. Cl. C11D 1/94; C11D 1/66; C11D 1/72; C11D 1/90; C11D 3/20; C11D 3/40; C11D 3/43; C11D 17/00

(52) U.S. Cl. CPC C11D 1/94; C11D 3/2068; C11D 3/40; C11D 3/43; C11D 17/0043; C11D 1/662; C11D 1/72; C11D 1/90

(57) ABSTRACT

A cleaning product including a spray dispenser and a cleaning composition, which provides effective removal of crystalline fats without compromising the stability and functionality of the spray detergent, especially at more neutral pH, is achieved by formulating the spray cleaning composition using alkyl polyglucoside nonionic surfactant and little or no anionic surfactant, in combination with at least two glycol ether solvents.

### TECHNICAL FIELD

The present disclosure relates to a cleaning product comprising a spray dispenser and a cleaning composition, which provides improved crystalline grease cleaning while also being more stable.

### BACKGROUND

Dishwashing detergents have long been used to facilitate the removal of grease, oils, and crystalline fats from cookware, dishes, and utensils. Traditional dishwashing detergents are generally available in liquid form and are effective in removing a wide range of food residues.

In recent years, there has been an increased demand for convenient and efficient dishwashing products that provide a quick and effective cleaning solution. In response to this demand, dishwashing detergent sprays have gained popularity as a convenient and time-saving alternative to traditional dishwashing methods. Hand dishwashing detergent sprays typically consist of a liquid detergent composition contained in a container comprising a manually activated spray nozzle. When the nozzle is actuated, the detergent is dispensed as a fine mist or spray, allowing for targeted application onto soiled dishware surfaces. The user can then scrub the treated surface to loosen and remove food residues. However, for increased convenience and efficiency, it is desirable that the spray composition solubilises and “lifts off” greasy stains with little or no scrubbing required.

While dishwashing detergent sprays offer convenience and ease of use, they face challenges when it comes to effectively removing crystalline fats. Crystalline fats, such as beef, lard, and other animal fats, can be particularly stubborn to remove. The surface tension and adhesion properties of crystalline fats make them resistant to regular dishwashing detergents, resulting in incomplete or unsatisfactory cleaning, or requiring greater manual effort. Compositions comprising high levels of anionic surfactants, such as alkyl ethoxylated sulfate surfactants, are particularly effective at removing liquid greasy stains. However, the over-spray from such anionic-rich compositions is more likely to cause nasal and eye irritation. Formulating the spray detergent composition to be nonionic rich, with only limited amounts of or absence of anionic surfactant, results in an over-spray which is less irritating to the nasal passages and eyes. However, such compositions are significantly less able to lift-off crystalline fats with little or no scrubbing.

To address this issue, solvents have been incorporated into dishwashing detergent sprays to enhance the removal of crystalline fats. Hydrophobic solvents, such as tripropylene glycol n-butyl ether and the like, are particularly effective for dissolving and dispersing fat molecules, making them more easily removable, even with little or no scrubbing.

While such solvents are particularly effective at removing crystalline fats, they are challenging to stably formulate into detergent compositions, especially detergent compositions for hand dish spray applications, which have both low viscosity, and relatively low levels of surfactant. Such hydrophobic solvents may affect the composition viscosity, surface tension, and emulsion stability of the detergent formulation, leading to phase separation, sedimentation, or decreased shelf life. A less stable detergent spray composition may result in reduced performance, poor spray pattern, clogging of the nozzle, or limited shelf life, which may limit the commercial viability and consumer acceptance of such products. The hydrophobic solvent may be solubilised through the use of a co-solvent. However, it has been found that such co-solvents typically reduce the efficacy of the hydrophobic solvent.

Improved removal of non-crystalline greasy and oily residues can be achieved by formulating the spray detergent composition to be rich in nonionic surfactants, especially alkyl polyglucosides, while limiting the level of anionic surfactant. However, stably formulating hydrophobic solvents such as tripropylene glycol n-butyl ether, and the like, is even more challenging when the detergent composition comprised only low levels, or no anionic surfactant.

A high pH is typically used to improve grease removal efficacy. However, a high pH is typically detrimental to perfume stability, since many perfume ingredients are less chemically or physically stable at high pH.

Therefore, there is a need for an improved dishwashing detergent spray composition that effectively removes crystalline fats without compromising the stability and functionality of the spray detergent, especially at more neutral pH, and results in an over-spray which is less irritating to nasal passages and eyes.

### SUMMARY

The present disclosure relates to a cleaning product comprising a spray dispenser and a cleaning composition, the composition is housed in the spray dispenser and wherein the cleaning composition comprises: 2% to 25% by weight of the composition of a surfactant system comprising: alkyl polyglucoside surfactant; a co-surfactant selected from amphoteric surfactant, zwitterionic surfactant and mixtures thereof; and less than 3% by weight of the cleaning composition of anionic surfactant; and glycol ether solvent, wherein the glycol ether solvent comprises: a glycol ether solvent of formula (I): R¹O(R²O)₃R³, wherein R¹ is a linear or branched C4, C5 or C6 alkyl or a substituted or unsubstituted phenyl; R² is ethyl or propyl; and R³ is hydrogen or methyl; and a glycol ether solvent of formula (II): R⁴O(R⁵O)₃R⁶, wherein R⁴ is methyl or ethyl, R⁵ is ethyl or propyl; and R⁶ is hydrogen or methyl; wherein the composition comprises from 1.0% to 15% by weight of the total composition of the glycol ether solvents, and the composition comprises the glycol ether solvent of formula (I) and the glycol ether solvent of formula (II) in a weight ratio of less than 2.5:1.

### DETAILED DESCRIPTION

The need for a cleaning product comprising a spray dispenser and a cleaning composition, which provides improved crystalline grease cleaning without compromising formulation stability is met by formulating the cleaning composition with a surfactant system comprising an alkyl polyglucoside surfactant and a co-surfactant which is an amphoteric surfactant and/or a zwitterionic surfactant, while limiting the amount of anionic surfactant being present, in combination with a solvent system, as described herein. Such cleaning compositions have been found to better improve the softening of the crystalline grease, and hence aid its removal from the dishware article being treated. Moreover, since the detergent composition is comprised in a spray container, the composition can be uniformly applied to the surface of the article and left for a period in order to further loosen crystalline grease, as part of a pretreatment step before the main cleaning step.

The present disclosure relates to a cleaning product, which is a hand dishwashing cleaning product, the product comprising a spray dispenser and a cleaning composition. The cleaning composition is comprised within the spray dispenser.

For the purpose of the present disclosure “dishware” encompasses all the items used to either cook or used to serve and eat food.

By “spray dispenser” is herein meant a container comprising a housing to accommodate the composition and means to spray that composition. The preferred spraying means being a trigger spray. The composition of use in the present disclosure foams when it is sprayed on the surface to be treated.

### Cleaning Composition:

The cleaning composition is preferably a hand dishwashing cleaning composition, preferably in liquid form. The cleaning composition is suitable for spraying.

The pH of the composition can be greater than or equal to 6, more preferably from 6 to 12 and most preferably from 6.5 to 8.0, as measured neat at 20° C. Typically, a higher pH is desired for improved liquid grease removal. However, a more neutral pH for the present composition has been found to improve the removal of crystalline fats, especially when scrubbing is limited. Moreover, perfume compositions are typically less stable at higher pH and hence, an improved perfume odour can be achieved when formulating the composition using a more neutral pH.

The cleaning product according to the present disclosure can comprise a composition having a Newtonian viscosity, such as from 1 mPa·s to 50 mPa·s, preferably from 1 mPa·s to 20 mPa·s, more preferably from 1 mPa·s to 10 mPa·s, at 20° C. as measured using the method defined herein.

Alternatively the cleaning product according to the present disclosure can comprise a composition having a shear thinning rheology profile, such as having a high shear viscosity of from 1 mPa·s to 50 mPa·s, preferably from 1 mPa·s to 20 mPa·s, more preferably from 5 mPa·s to 15 mPa·s, when measured at a shear rate of at 1000 s⁻¹ at 20° C., and a low shear viscosity of from 100 mPa·s to 1,000 mPa·s, preferably from 200 mPa·s to 500 mPa·s, when measured at 0.1 s⁻¹ at 20° C., using the method defined herein.

Preferably the cleaning composition of use in the present disclosure has a Newtonian viscosity.

The liquid cleaning composition typically comprises an aqueous carrier in which all the other composition actives are dissolved or eventually dispersed. As such, water can be present in an amount of from 60% to 90%, preferably from 75% to 85% by weight of the composition.

The liquid cleaning composition comprises a surfactant system and a glycol ether solvent system.

The surfactant system and the glycol ether solvents are preferably in a weight ratio of from 3:1 to 1:3, preferably from 1.5:1 to 1:2, most preferably 1:1 to 1:1.5. Compositions of use in the present disclosure, having such a weight ratio of surfactant system to glycol ether solvents have been found to provide improved coverage on the dishware with minimum over-spray (residual spray droplets remaining in suspension in the air). Therefore, such spray compositions reduce wastage and minimise the amount of spray droplets which can be inhaled.

### Surfactant System:

The composition comprises from 2% to 20%, preferably from 3% to 15%, more preferably from 3.5% to 8.0% by weight of the composition of the surfactant system. The surfactant system comprises an alkyl polyglucoside surfactant. The surfactant system comprises a co-surfactant selected from the group consisting of amphoteric surfactant, zwitterionic surfactant, and mixtures thereof, preferably an amphoteric surfactant, more preferably an amine oxide surfactant. The alkyl polyglucoside surfactant and co-surfactant can be present at a weight ratio of from greater than 10:1 to 1:10, preferably from 5:1 to 1:5, more preferably from 2:1 to 1:2.

### Alkyl Polyglucoside Surfactant:

The surfactant system preferably comprises the alkyl polyglucoside (“APG”) at a level of from 0.5% to 10%, preferably from 1.0% to 5.0%, more preferably from 1.5% to 3.0% by weight of the composition.

For improved crystalline grease removal, the alkyl polyglucoside surfactant can have a number average alkyl carbon chain length between 8 and 18, preferably between 10 and 16, most preferably between 12 and 14, with an average degree of polymerization of between 0.1 and 3.0 preferably between 1.0 and 2.0, most preferably between 1.2 and 1.6.

For improved initial sudsing, the alkyl polyglucoside surfactant can have a number average alkyl carbon chain length between 8 and 18, preferably between 8 and 14, most preferably between 8 and 10, with an average degree of polymerization of between 0.1 and 3.0 preferably between 1.0 and 2.0, most preferably between 1.2 and 1.6.

C8-C18 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

### Co-Surfactants:

The co-surfactants are selected from amphoteric surfactant, zwitterionic surfactant and mixtures thereof. The cleaning composition can comprise the co-surfactant at a level of from 0.5% to 7.5%, preferably from 1.0% to 5.0%, more preferably from 1.5% to 3.0% by weight of the composition.

### Amphoteric Surfactant:

As mentioned earlier, amine oxide surfactants are preferred for use as a co-surfactant. The amine oxide surfactant can be linear or branched, though linear are preferred. Suitable linear amine oxides are typically water-soluble, and characterized by the formula R1-N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the αcarbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the present disclosure can then comprise:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

### Zwitterionic Surfactant:

In compositions of the present disclosure, the use of zwitterionic surfactants as a co-surfactant has been found to improve the removal of polymerised or “baked-on” grease. Suitable zwitterionic surfactants include betaine surfactants. Such betaine surfactants includes alkyl betaines, alkylamidobetaine, amidazoliniumbetaine, sulphobetaine (INCI Sultaines) as well as the Phosphobetaine, and preferably meets formula (II):

R¹—[CO—X(CH₂)ₙ]ₓ—N⁺(R²)(R₃)—(CH₂)ₘ—[CH(OH)—CH₂]_{y}—Y⁻
wherein in formula (II),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO3, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulphobetaines of formula (Ic) and the amido sulphobetaine of formula (Id):

R¹—N(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)
in which R1 has the same meaning as in formula (II). Particularly preferred are the carbobetaines [i.e. wherein Y—=COO— in formula (II)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Anionic Surfactant:

Should the detergent composition comprise an anionic surfactant, suitable anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a linear or branched C8-C22 alkyl, or acyl group. Such surfactants are employed in the form of water-soluble salts and the salt-forming cation usually is selected from sodium, potassium, ammonium, magnesium and mono-, di- or tri-alkanolammonium, with the sodium, cation being the usual one chosen.

Since anionic surfactants are not preferred for compositions of use in the present disclosure, the surfactant system comprises less than 3.0%, preferably less than 2.0%, more preferably less than 1.0% by weight of the detergent composition of an anionic surfactant. Most preferably the detergent composition according to the present disclosure is free of anionic surfactant.

### Further Non-Ionic Surfactant:

The surfactant system can comprise further non-ionic surfactant. If present, the surfactant system can comprise from 0.5% to 12%, preferably from 1.0% to 7.0%, more preferably from 2.0% to 6.0% by weight of the composition of the further nonionic surfactant.

Suitable further non-ionic surfactants include alkyl alkoxylated non-ionic surfactants, more preferably ethoxylated non-ionic surfactants. Suitable nonionic surfactants include the condensation products of aliphatic alcohols with from 1 to 25 moles of ethylene oxide. The alkyl chain of the aliphatic alcohol can either be straight or branched, primary or secondary, preferably straight

The further nonionic surfactant is preferably a low-cut alkyl ethoxylate surfactant. Low-cut alcohol ethoxylate surfactants include alcohol ethoxylate surfactants with an average alkyl carbon chain length of C10 and below. More preferably the alkyl ethoxylate surfactant has an average alkyl chain length of between C5 to C8, preferably between C5 to C7, and a number average degree of ethoxylation of from 1 to 10, preferably from 3 to 8, more preferably from 4 to 6. Suitable non-ionic alcohol ethoxylate surfactants include commercially available materials such as Emulan® HE50 or Lutensol® CS6250 (available from BASF).

Other suitable non-ionic surfactants for use herein can be selected from fatty alcohol polyglycol ethers, fatty acid glucamides, and mixtures thereof.

Most preferably the surfactant system consists of an alkyl polyglucoside surfactant, an amine oxide surfactant and an alkyl ethoxylate surfactant, especially a low-cut alcohol ethoxylate surfactant as described earlier.

### Other Surfactant:

The compositions of use in the present disclosure are preferably free of cationic surfactant and especially free of antimicrobial cationic surfactants, since such surfactants are typically detrimental to grease cleaning and surface shine. Such antimicrobial cationic surfactants include quaternary ammonium compounds such as dodecyl dimethyl ammonium chloride, alkyl dimethyl benzyl ammonium chloride, alkyl dimethyl ethylbenzyl ammonium chloride, and mixtures thereof.

### Glycol Ether Solvent:

The combination of glycol ether solvents, as described herein, have been found to be particularly effective when used in combination with the alkyl polyglucoside to remove crystalline grease, even at more neutral pH, while still providing a stable composition. In particular, the composition comprises glycol ether solvent, wherein the glycol ether solvent comprises:
a. a glycol ether solvent of formula (I): R¹O(R²O)₃R³, wherein R¹ is a linear or branched C4, C5 or C6 alkyl or a substituted or unsubstituted phenyl; R² is ethyl or propyl, such as isopropyl; and R³ is hydrogen or methyl; and
b. a glycol ether solvent of formula (II): R⁴O(R⁵O)₃R⁶, wherein R⁴ is methyl or ethyl, R⁵ is ethyl or propyl, such as isopropyl; and R⁶ is hydrogen or methyl.

The glycol ether solvents of formula (I) are particularly effective at removing crystalline fats from dishware, even with little or no scrubbing. Such solvents are thought to be effective at removing such crystalline fats since they are hydrophobic. However, the hydrophobic nature of such solvents results in them being challenging to formulate in aqueous detergent compositions, especially aqueous detergent compositions that are suitable for spraying, since such compositions typically have a low viscosity and relative low levels of surfactant. Moreover, they are typically less stable in compositions which comprise only low levels, or no anionic surfactant. For such solvents, there is typically a need to incorporate a co-solvent into the composition, in order to stably formulate the solvent of formula (I). However, by solubilising the solvent of formula (I), it has been found that they become less effective at removing crystalline fats from dishware.

In the present disclosure, the glycol ether solvent of formula (II) is incorporated into the formulation, in order to stably formulate the glycol ether solvent of formula (I), while having a negligible effect on the fat-removal efficacy of the solvent.

In the glycol ether solvent of formula (I):
a. R¹ is preferably a linear or branched C4 or C5, preferably linear or branched C4, more preferably linear butyl;
b. R² is preferably propyl, more preferably isopropyl;
c. R³ is preferably hydrogen.

Suitable glycol ether solvents according to Formula (I) include: triethyleneglycol n-butyl ether, triethyleneglycol isobutyl ether, triethyleneglycol n-pentyl ether, triethyleneglycol isopentyl ether, triethyleneglycol n-hexyl ether, triethyleneglycol isohexyl ether, triethyleneglycol phenyl ether, tripropyleneglycol n-butyl ether, tripropyleneglycol isobutyl ether, tripropyleneglycol n-pentyl ether, tripropyleneglycol isopentyl ether, tripropyleneglycol n-hexyl ether, tripropyleneglycol isohexyl ether, tripropyleneglycol phenyl ether, triethyleneglycol methyl n-butyl ether, triethyleneglycol isobutyl methyl ether, triethyleneglycol methyl n-pentyl ether, triethyleneglycol isopentyl methyl ether, triethyleneglycol methyl n-hexyl ether, triethyleneglycol isohexyl methyl ether, triethyleneglycol methyl phenyl ether, tripropyleneglycol methyl n-butyl ether, tripropyleneglycol isobutyl methyl ether, tripropyleneglycol methyl n-pentyl ether, tripropyleneglycol isopentyl methyl ether, tripropyleneglycol methyl n-hexyl ether, tripropyleneglycol isohexyl methyl ether, tripropyleneglycol methyl phenyl ether, or mixtures thereof, preferably tripropyleneglycol n-butyl ether, tripropyleneglycol isobutyl ether, tripropyleneglycol n-pentyl ether, tripropyleneglycol isopentyl ether, or mixtures thereof, most preferably tripropyleneglycol n-butyl ether, tripropyleneglycol isobutyl ether, or a mixture thereof. Suitable glycol ether solvents of formula (I) can be purchased from The Dow Chemical Company, in particularly under the Dowanol® E or P-series, such as Dowanol® TPnB.

In the glycol ether solvent of formula (II):
a. R⁴ is preferably C1, preferably methyl;
b. R⁵ is preferably propyl, more preferably isopropyl;
c. R⁶ is preferably hydrogen.

Suitable glycol ether solvents according to Formula (II) include: triethyleneglycol methyl ether, triethyleneglycol ethyl ether, tripropyleneglycol methyl ether, tripropyleneglycol ethyl ether, triethyleneglycol dimethyl ether, triethyleneglycol ethyl methyl ether, tripropyleneglycol dimethyl ether, tripropyleneglycol ethyl methyl ether, or a mixture thereof, preferably tripropyleneglycol methyl ether. Suitable glycol ether solvents of formula (I) can be purchased from The Dow Chemical Company, in particularly under the Dowanol® E or P-series, such as Dowanol® TPM.

The composition comprises from 1.0% to 15%, preferably from 2.0% to 10.0%, more preferably from 4.5% to 7.5% by weight of the total composition of the glycol ether solvents.

The composition comprises the glycol ether solvent of formula (I) and the glycol ether solvent of formula (II) in a weight ratio of less than 2.5:1, preferably from 1:1 to 2.25:1, more preferably from 1.25:1 to 2.0:1. When formulated in the aforementioned ratio, the stability of the glycol ether solvent of formula (I) in compositions comprising little or no anionic surfactant is particularly improved, without affecting the crystalline grease removal efficacy of the composition.

### Further Optional Ingredients:

### Perfume:

The composition preferably comprises perfume. The perfume can be present at a level of from 0.05% to 2.5%, preferably from 0.1% to 2.0%, more preferably from 0.3% to 1.0% by weight of the composition. As mentioned earlier, there are several perfume ingredients, and especially perfume ingredients derived from natural extracts, that typically are not stable at high pH levels. Such perfume ingredients can include essential oils, such as lemon, lime, orange, and patchouli, which typically contain volatile compounds that can degrade or evaporate at high pH. Floral extracts such as rose, lavender, and jasmine, are also typically sensitive to alkaline conditions, losing their fragrance or undergoing chemical changes at high pH levels. Perfume esters, aldehydes and ketones also undergo chemical reactions or degrade at high pH, resulting in a loss of scent or changes in the fragrance profile. Some natural resins, such as benzoin or myrrh, become less soluble or undergo chemical changes, affecting their scent characteristics, at high pH.

Since the compositions of the present disclosure are effective at more neutral pH, the present compositions preferably comprise perfume, preferably wherein the perfume comprises perfume ingredients selected from essential oils, floral extracts, perfume esters, perfume aldehydes, perfume ketones, and mixtures thereof.

### Further Organic Solvent:

The composition may further comprise from 0.01% to 5% by weight of the composition of an organic solvent selected from the group consisting of C2-C4 alcohols, C2-C4 polyols, poly alkylene glycols and especially polypropyleneglycols having a weight average molecular weight of from 1500 to 4,000, and mixtures thereof.

### Chelant:

The composition herein may optionally further comprise a chelant at a level of from 0.1% to 10%, preferably from 0.2% to 5%, more preferably from 0.2% to 3%, most preferably from 0.5% to 1.5% by weight of the composition.

Suitable chelating agents can be selected from the group consisting of amino carboxylates, amino phosphonates, polyfunctionally-substituted aromatic chelating agents and mixtures thereof.

Amino carboxylates include ethylenediaminetetra-acetates, N-hydroxyethylethylenediaminetriacetates, nitrilo-triacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein, as well as MGDA (methyl-glycine-diacetic acid), and salts and derivatives thereof and GLDA (glutamic-N,N-diacetic acid) and salts and derivatives thereof. GLDA (salts and derivatives thereof) is especially preferred according to the present disclosure, with the tetrasodium salt thereof being especially preferred.

### Builder:

The composition herein may comprise a builder, preferably a carboxylate builder. Salts of carboxylic acids useful herein include salts of C1-6 linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred salts of carboxylic acids are those selected from the salts from the group consisting of salicylic acid, maleic acid, acetyl salicylic acid, 3 methyl salicylic acid, 4 hydroxy isophthalic acid, dihydroxyfumaric acid, 1, 2, 4 benzene tricarboxylic acid, pentanoic acid, citric acid, and mixtures thereof, preferably citric acid.

Alternative carboxylate builders suitable for use in the composition of the present disclosure includes salts of fatty acids like palm kernel derived fatty acids or coconut derived fatty acid, or salts of polycarboxylic acids.

The cation of the salt is preferably selected from alkali metal, alkaline earth metal, monoethanolamine, diethanolamine or triethanolamine and mixtures thereof, preferably sodium.

The carboxylic acid or salt thereof, when present, is preferably present at the level of from 0.05% to 5%, more preferably from 0.1% to 1% by weight of the total composition.

### Hydrotropes

The composition according to the present disclosure might further comprise a hydrotrope. Preferably the hydrotrope is selected from cumene sulphonate, xylene sulphonate, toluene sulphonate, most preferably sodium neutralized cumene sulphonate. When present the hydrotrope is formulated from 0.1% to 5%, preferably from 0.25% to 3%, most preferably from 0.5% to 2% by weight of the detergent composition.

### Shear Thinning Rheology Modifier:

The composition according to the present disclosure might further comprise a rheology modifying agent, providing a shear thinning rheology profile to the product. Formulating with a rheology modifying polymer can improve particle size distribution of the resultant spray, as well as mitigating any stinging effect of the spray droplets. Preferably the rheology modifying agent is a non crystalline polymeric rheology modifier. This polymeric rheology modifier can be a synthetic or a naturally derived polymer.

Examples of naturally derived polymeric structurants of use in the present disclosure include: hydroxyethyl cellulose, hydrophobically modified hydroxyethyl cellulose, carboxymethyl cellulose, polysaccharide derivatives and mixtures thereof. Polysaccharide derivatives include but are not limited to pectine, alginate, arabinogalactan (gum Arabic), carrageenan, gum karaya, gum tragacanth, gellan gum, xanthan gum and guar gum. Examples of synthetic polymeric structurants of use in the present disclosure include polymers and copolymers comprising polycarboxylates, polyacrylates, polyurethanes, polyvinylpyrrolidone, polyols and derivatives and mixtures thereof. Alternatively the composition of use in the present disclosure can comprise a polyethylenoxide (PEO) polymer.

Preferably the composition according to the present disclosure comprises a rheology modifying polymer selected from a naturally derived rheology modifying polymer, most preferably Xanthan Gum, a polyethylenoxide, or mixtures thereof.

Generally, the rheology modifying polymer will be comprised at a level of from 0.001% to 1% by weight, alternatively from 0.01% to 0.5% by weight, more alternatively from 0.05% to 0.25% by weight of the composition.

### Other Ingredients:

The compositions of the present disclosure can comprise a cleaning amine such as a cyclic cleaning amine. The term “cyclic diamine” herein encompasses a single cleaning amine and a mixture thereof. The amine can be subjected to protonation depending on the pH of the cleaning medium in which it is used. Especially preferred for use herein are cyclic diamines selected from the group consisting of 1, 3-bis(methylamine)-cyclohexane, 2-methylcyclohexane-1,3-diamine, 4-methylcyclohexane-1,3-diamine and mixtures thereof. 1, 3-bis(methylamine)-cyclohexane is especially preferred for use herein. Mixtures of 2-methylcyclohexane-1,3-diamine, 4-methylcyclohexane-1,3-diamine are also preferred for use herein.

The composition might also comprise pH trimming and/or buffering agents such as sodium hydroxyde, alkanolamines including monoethanolamine, and bicarbonate inorganic salts. The composition might comprise further minor ingredients selected from preservatives, UV stabilizers, antioxidants, perfumes, coloring agents and mixtures thereof.

### Spray Dispenser:

The spray dispenser comprises a reservoir to accommodate the composition of the present disclosure and spraying means. Suitable spray dispensers include hand pump (sometimes referred to as “rigger”) devices, pressurized can devices, electrostatic spray devices, etc., Preferably the spray dispenser is non-pressurized and the spray means are of the trigger dispensing type. The reservoir is typically a container such as a bottle, more typically a plastic bottle.

The cleaning product of the present disclosure includes the cleaning composition. The cleaning composition is typically suitable for spraying from the spray dispenser onto the dish surface to be treated (“direct application”). The composition preferably forms a foam on the surface immediately upon application without requiring any additional physical (e.g., manual rubbing) intervention.

The spray dispenser typically comprises a trigger lever which, once depressed, activates a small pump. The main moving element of the pump is typically a piston, housed inside a cylinder, with the piston pressing against a spring. By depressing the trigger, the piston is pushed into the cylinder and against the spring, compressing the spring, and forcing the composition contained within the pump out of a nozzle. Once the trigger lever is released, the spring pushes the piston back out, expanding the cylinder area, and sucking the composition from the reservoir, typically through a one-way valve, and refilling the pump. This pump is typically attached to a tube that draws the composition from the reservoir into the pump. The spray dispenser can comprise a further one-way valve, situated between the pump and the nozzle.

The nozzle comprises an orifice through which the composition is dispensed. The nozzle utilises the kinetic energy of the composition to break it up into droplets as it passes through the orifice. Suitable nozzles can be plain, or shaped, or comprise a swirl chamber immediately before the orifice. Such swirl chambers induce a rotary fluid motion to the composition which causes swirling of the composition in the swirl chamber. A film is discharged from the perimeter of the orifice which typically results in dispensing the composition from the orifice as finer droplets.

Since such trigger-activated spray dispensers comprise a pump, the composition preferably is not pressurized within the reservoir and preferably does not comprise a propellant.

The spray dispenser can be a pre-compression sprayer which comprises a pressurized buffer for the composition, and a pressure-activated one-way valve between the buffer and the spray nozzle. Such precompression sprayers provide a more uniform spray distribution and more uniform spray droplet size since the composition is sprayed at a more uniform pressure. Such pre-compression sprayers include the Flairosol® spray dispenser, manufactured and sold by Afa Dispensing Group (The Netherlands) and the pre-compression trigger sprayers described in U.S. Patent Publication Nos. 2013/0112766 and 2012/0048959.

### Method of Use:

The cleaning products, as described herein, are particularly suited for methods of cleaning dishware comprising the steps of: optionally pre-wetting the dishware; spraying the cleaning composition onto the dishware; optionally scrubbing the dishware; and rinsing the dishware.

The cleaning products described herein are particularly effective at loosening soils, and especially greasy soils. As such, especially for light soiling, scrubbing is optional, and particularly when the dishware is left for at least 15 seconds, preferably at least 30 seconds after the spray step, before the rinsing step is done.

The steps of scrubbing of the dishware and rinsing the dishware can take place at least partially simultaneously, for example, by scrubbing the dishware under running water or when the dishware is submerged in water. The scrubbing step can take between 1 second and 30 seconds.

The present method allows for faster and easier cleaning of dishware when the dishware is lightly soiled. When the dishware is heavily soiled with tough food soils such as cooked-, baked- or burnt-on soils, the present method facilitates the cleaning when the soiled dishware is soaked with the product of the present disclosure in neat form or diluted in water, preferably for a period of from 1 second to 30 seconds, or longer.

### METHODS

### A) Viscosity:

The rheology profile is measured using a “TA instruments DHR1” rheometer, using a cone and plate geometry with a flat steel Peltier plate and a 60 mm diameter, 2.0260 cone (TA instruments, serial number: SN960912). The viscosity measurement procedure includes a conditioning step and a sweep step at 20° C. The conditioning step consists of a 10 seconds at zero shear at 20° C., followed by pre-shearing for 10 seconds at 10 s⁻¹ at 20° C., followed by 30 seconds at zero shear at 20° C. in order for the sample to equilibrate. The sweep step comprises a logarithmical shear rate increase in log steps starting from 0.01 s⁻¹ to 3,000 s⁻¹ at 20° C., with a 10 points per decade acquisition rate taken in a sample period of 15 s, after a maximum equilibration time of 200 seconds (determined by the rheometer, based on a set tolerance of 3%). When measuring shear thinning product compositions, the high shear viscosity is defined at a shear rate of 1,000 s⁻¹, and the low shear viscosity at a shear rate of 0.1 s⁻¹. For Newtonian product compositions the shear rate is recorded at 1,000 s⁻¹.

### B) Stability:

The liquid composition is stored in 30 ml glass vials at 50 C temperature for 1 day after which the phase stability of the liquid composition is visually assessed.

### C) Crystalline Grease Removal:

To be able to cross-compare the crystalline grease removal potential of a range of test compositions, the test compositions are sprayed onto soiled substrates comprising the crystalline grease, and the % removal after a cleaning test is assessed via visual grading, as described below.

The crystalline greasy soil that was used comprised mixture of CABF (Consumer Average Beef Fat, L2802405/200B3/E3 supplied by: J&R coordinating services Inc, Ohio, USA) and a fat soluble dye added at a level of 0.05 wt % (Dye EGN Oil Red:CAS: 4477-79-6, Sigma Aldrich Ref. 234117). The crystalline greasy soil was prepared by melting the CABF in a 50° C. oven until the fully liquefied, before mixing in the dye.

Molten CABF, at a temperature of 50° C., was deposited on to an enamel tile (white enamel tile, of size 25 cm by 7 cm, supplied by Emaillerie Belge, Rue Saint-Denis 122, 1190 Forest, BE) homogeneously over the full surface of the tile using a synthetic foam paint roller until an amount of 0.65 g+/−0.05 g of CABF has been deposited onto the tile. The tile is left 3 hours at 23° C. and 50RH humidity before being used in the test.

For each test composition, the test was repeated three times using three different enamel tiles.

The three tiles were placed horizontally on to a surface. The test solution was sprayed 6 times for a total of approximately 5 seconds, covering half of the tile surface, using a Flairosol® sprayer (supplied by AFA) and left to act for 4 minutes. The tiles were then repositioned vertically and 20 mL of demineralised water is sprayed twice onto the tile to rinse off the foam using a 20 mL syringe.

The tiles were photographed using a digital camera and then visually grades on a 0 to 5 scale, with no change being graded 0, and complete removal of the crystalline grease being graded 5.

### EXAMPLES

The crystalline grease removal efficacy was assessed for liquid detergent spray compositions according to the present disclosure and comparative compositions outside the scope of the present disclosure.

In table 1, inventive example 1 comprised a surfactant system consisting of C8 to C10 alkyl polyglucoside, C12 to 14 dimethylamine oxide as the co-surfactant, and C6EO5 nonionic surfactant, in addition to a combination of a solvent of formula (I), tripropylene glycol n-butyl ether and a solvent of formula (II), tripropylene glycol methyl ether. The resultant composition was both stable and effective at removing crystalline fats with little or no scrubbing. Comparative example A was similar to example 1 but did not comprise a solvent of formula (II). As such, while the composition was effective at removing crystalline grease, the composition was not stable and phase split. Comparative example B was similar to example 1 but comprised ethanol instead of a solvent of formula (II). As such, while the composition was stable, the solvent of formula (I) was less effective in the composition at removing crystalline grease.

Inventive example 2 was similar to example 1 but had a pH of 7.0 instead of 11.2. By comparing the results from inventive example 2 with those from inventive example 1, it can be seen that the removal of crystalline fat with little or no scrubbing is improved as the composition is formulated to have a more neutral pH. Comparative example C was similar to example 2 but did not comprise a solvent of formula (II). As such, while the composition was effective at removing crystalline grease, the composition was not stable and phase split. Comparative example D was similar to example 2 but comprised ethanol instead of a solvent of formula (II). As such, while the composition was stable, the solvent of formula (I) was less effective in the composition at removing crystalline grease.

Comparing the results from comparative examples C and to those from inventive example 2 shows that the benefit of the combination of solvents of formula (I) and (II) are also present at the lower pH, where ingredients such as perfumes are chemically and odour-wise more stable.

TABLE 1
Inventive and comparative liquid spray detergent compositions
comprising lower levels of the surfactant system, the surfactant
system comprising a low-chain length alkyl polyglucoside.

| | Ex 1 | Ex A* | Ex B* | Ex 2 | Ex C* | Ex D* |
|---|---|---|---|---|---|---|
| C8 to C10 alkyl | 2.0 | 2.0 | 2.0 | 2.0 | 2.0 | 2.0 |
| polyglucoside1 | | | | | | |
| C12 to 14 dimethylamine | 2.0 | 2.0 | 2.0 | 2.0 | 2.0 | 2.0 |
| oxide | | | | | | |
| C6E05 nonionic surfactant² | 1.0 | 1.0 | 1.0 | 1.0 | 1.0 | 1.0 |
| Tripropylene glycol n-butyl | 3.0 | 3.0 | 3.0 | 3.0 | 3.0 | 3.0 |
| ether³ | | | | | | |
| Tripropylene glycol methyl | 3.0 | — | — | 3.0 | — | — |
| ether⁴ | | | | | | |
| Ethanol | — | — | 3.0 | — | — | 3.0 |
| Tetrasodium glutamate | 1.0 | 1.0 | 1.0 | 1.0 | 1.0 | 1.0 |
| diacetate | | | | | | |
| Triethanolamine | 1.0 | 1.0 | 1.0 | 1.0 | 1.0 | 1.0 |
| Citric acid | 0.1 | 0.1 | 0.1 | 0.7 | 0.7 | 0.7 |
| water | to 100% | to 100% | to 100% | to 100% | to 100% | to 100% |
| perfume | 0.3 | 0.3 | 0.3 | 0.3 | 0.3 | 0.3 |
| pH (neat) | 11.2 | 11.2 | 11.2 | 7.0 | 7.0 | 7.0 |
| Stable | Yes | No | Yes | Yes | No | Yes |
| Grease removal | 4 | 4 | 1 | 5 | 5 | 2 |

*Comparative
¹Glucopon ® 215, supplied by BASF
²Lutensol ® CS6250, supplied by BASF
³Solvent of formula (I), sold under the Dowanol TPNB tradename, supplied by DOW
⁴Solvent of formula (II), sold under the Dowanol TPM tradename, supplied by DOW

In table 2, inventive example 3 comprised a surfactant system consisting of C12 to C14 alkyl polyglucoside, C12 to 14 dimethylamine oxide as the co-surfactant, and C6EO5 nonionic surfactant, in addition to a combination of a solvent of formula (I), tripropylene glycol n-butyl ether and a solvent of formula (II), tripropylene glycol methyl ether. The resultant composition was both stable and effective at removing crystalline fats with little or no scrubbing. Comparative example E was similar to example 3 but did not comprise a solvent of formula (II). As such, while the composition was effective at removing crystalline grease, the composition was not stable and phase split. Comparative example F was similar to example 1 but comprised ethanol instead of a solvent of formula (II). As such, while the composition was stable, it was less effective at removing crystalline grease.

Inventive example 4 was similar to example 3 but had a pH of 7.0 instead of 11.2. By comparing the results from inventive example 4 with those from inventive example 3, it can be seen that the removal of crystalline fat with little or no scrubbing is improved as the composition is formulated to have a more neutral pH.

Comparing the results from comparative examples G and H to those from inventive example 3 shows that the benefit of the combination of solvents of formula (I) and (II) are also present at the lower pH.

The results of inventive examples 1 to 2, and 3 to 4, demonstrate that the benefit of a combination of solvents of formula (I) and (II) is present over a broad range of surfactant levels and when the surfactant system comprises alkyl polyglucosides of different chain lengths.

TABLE 2
Inventive and comparative liquid spray detergent compositions
comprising higher levels of the surfactant system, the surfactant
system comprising a mid-chain length alkyl polyglucoside.

| | Ex 3 | Ex E* | Ex F* | Ex 4 | Ex G* | Ex H* |
|---|---|---|---|---|---|---|
| C12 to C14 alkyl polyglucoside⁵ | 3.5 | 3.5 | 3.5 | 3.5 | 3.5 | 3.5 |
| C12 to 14 dimethylamine oxide | 3.5 | 3.5 | 3.5 | 3.5 | 3.5 | 3.5 |
| C6E05 nonionic surfactant² | 4.0 | 4.0 | 4.0 | 4.0 | 4.0 | 4.0 |
| Tripropylene glycol n-butyl ether³ | 3.5 | 3.5 | 4.0 | 3.5 | 3.5 | — |
| Tripropylene glycol methyl ether⁴ | 3.5 | — | 5.0 | 3.5 | — | — |
| Dipropylene glycol n-butyl ether⁶ | — | — | — | — | — | 4.0 |
| Ethanol | — | — | — | — | — | 0.3 |
| perfume | 0.3 | 0.3 | 0.3 | 0.3 | 0.3 | 0.3 |
| water | to | to | to | to | to | to |
| | 100% | 100% | 100% | 100% | 100% | 100% |
| pH (neat) | 11.2 | 11.2 | 11.2 | 7.0 | 7.0 | 7.0 |
| Stable | Yes | No | Yes | Yes | No | Yes |
| Grease removal | 4 | 4 | 2 | 5 | 5 | 1 |

¹ Glucopon ® 600, supplied by BASF
⁶alternative ether solvent, sold under the Dowanol DPNB tradename, supplied by DOW

In table 3, comparative example I and inventive examples 5 to 7 comprised the same surfactant system and the same level of the glycol ether solvent of formula (I), with decreasing weight ratio of the solvent of formula (I) to solvent of formula (II). The results show that improved stability is achieved when the weight ratio of the solvent of formula (I) to solvent of formula (II) is less than 2.5 or less than 2.0.

TABLE 3
Inventive liquid spray detergent compositions comprising
different weight ratios of solvent (I) and (II).

| | Ex I* | Ex 5 | Ex 6 | Ex 7 |
|---|---|---|---|---|
| C12 to C14 alkyl polyglucoside¹ | 3.5 | 3.5 | 3.5 | 3.5 |
| C12 to 14 dimethylamine oxide | 3.5 | 3.5 | 3.5 | 3.5 |
| C6EO5 nonionic surfactant³ | 4.0 | 4.0 | 4.0 | 4.0 |
| Tripropylene glycol n-butyl ether⁴ | 5.5 | 5.5 | 5.5 | 5.5 |
| Tripropylene glycol methyl ether⁵ | 2.0 | 3.0 | 4.0 | 5.0 |
| perfume | 0.3 | 0.3 | 0.3 | 0.3 |
| water | to | to | to | to |
| | 100% | 100% | 100% | 100% |
| pH (neat) | 7.0 | 7.0 | 7.0 | 7.0 |
| Wt ratio of glycol ether solvent | 2.75 | 1.83 | 1.37 | 1.10 |
| of formula (I) to glycol ether | | | | |
| solvent of formula (II) | | | | |
| Stable | No | Yes | Yes | Yes |
| Grease removal | 5 | 5 | 5 | 4.5 |

In table 4, the examples comprised anionic surfactant at a level of over 3.0% by weight of the composition. As such, both compositions were comparative. Examples J and K show that compositions which comprise high levels of anionic surfactant already provide good stability, and that in such anionic-rich compositions, the problem of stably formulating the hydrophobic glycol ether solvents of formula (I) is not present. However, as mentioned herein, the over-spray from such compositions has a greater tendency to cause nasal and eye irritation.

TABLE 4
Comparative liquid spray detergent compositions wherein the
surfactant system, comprises anionic surfactant at a level of over
3.0% by weight of the composition, and no alkyl polyglucoside.

| | Ex J* | Ex K* |
|---|---|---|
| C1214AE3S anionic surfactant | 3.5 | 3.5 |
| C1214 dimethylamine oxide | 3.5 | 3.5 |
| C6EO5 nonionic surfactant³ | 4 | 4 |
| Tripropylene glycol n-butyl ether⁴ | | 6.5 |
| perfume | 0.3 | 0.3 |
| water | to | to |
| | 100% | 100% |
| pH (neat) | 7.0 | 7.0 |
| Stable | Yes | Yes |

The data of table 4 demonstrates that the challenge of stabilising liquid compositions comprising a glycol ether solvent of formula (I) is not present in compositions that comprise high levels of anionic surfactant.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any example disclosed or claimed herein or that it alone, or in any combination with any other reference or references, teaches, suggests or discloses any such example. Further, to the extent that any meaning or definition of a term in this document conflicts with any meaning or definition of the same term in a document incorporated by reference, the meaning or definition assigned to that term in this document shall govern.

While particular examples of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

What is claimed is:

1. A cleaning product comprising a spray dispenser and a cleaning composition, the composition is housed in the spray dispenser and wherein the cleaning composition comprises:
a. about 2% to about 20% by weight of the composition of a surfactant system comprising:
i. alkyl polyglucoside surfactant;
ii. a co-surfactant selected from amphoteric surfactant, zwitterionic surfactant and mixtures thereof; and
iii. less than about 3.0% by weight of the cleaning composition of anionic surfactant; and
b. glycol ether solvent, wherein the glycol ether solvent comprises:
i. a glycol ether solvent of formula (I): R¹O(R²O)₃R³, wherein R¹ is a linear or branched C4, C5 or C6 alkyl or a substituted or unsubstituted phenyl; R² is ethyl or propyl; and R³ is hydrogen or methyl; and
ii. a glycol ether solvent of formula (II): R⁴O(R¹O)₃R⁶, wherein R⁴ is methyl or ethyl, R⁵ is ethyl or propyl; and R⁶ is hydrogen or methyl;
wherein the composition comprises from about 1.0% to about 15% by weight of the total composition of the glycol ether solvents, and the composition comprises the glycol ether solvent of formula (I) and the glycol ether solvent of formula (II) in a weight ratio of less than 2.5:1.

2. The cleaning product according to claim 1, wherein the composition comprises from about 3% to about 15% by weight thereof of the surfactant system.

3. The cleaning product according to claim 1, wherein the cleaning composition comprises the alkyl polyglucoside at a level of from about 0.5% to about 7.5% by weight of the composition.

4. The cleaning product according to claim 1, wherein the alkyl polyglucoside surfactant comprises a C8-C18 alkyl chain, and wherein the alkyl polyglucoside surfactant has a number average degree of polymerization of from about 0.1 to about 3.0.

5. The cleaning product according to claim 1, wherein the cleaning composition comprises the co-surfactant at a level of from about 0.5% to about 7.5% by weight of the composition.

6. The cleaning product according to claim 1, wherein the co-surfactant is an amphoteric surfactant selected from amine oxide surfactant, wherein the amine oxide surfactant is selected from the group consisting of: alkyl dimethyl amine oxide, alkyl amido propyl dimethyl amine oxide, and mixtures thereof.

7. The cleaning product according to claim 6, wherein the amine oxide surfactant is alkyl dimethyl amine oxide.

8. The cleaning product according to claim 1, wherein the co-surfactant is a zwitterionic surfactant selected from betaine surfactant, wherein the betaine surfactant is selected from the group consisting of: cocamidopropyl betaine, cocobetaines, lauramidopropyl betaine, lauryl betaine, myristyl amidopropyl betaine, myristyl betaine, and mixtures thereof.

9. The cleaning product according to claim 8, wherein the betaine surfactant is cocamidopropyl betaine.

10. The cleaning product according to claim 1, wherein the alkyl polyglucoside surfactant and co-surfactant are present at a weight ratio of from greater than about 10:1 to about 1:10.

11. The cleaning product according to claim 1, wherein in the glycol ether solvent of formula (I):
R¹ is a linear or branched C4, C5;
R² is propyl; and
R³ is hydrogen.

12. The cleaning product according to claim 11, wherein in the glycol ether solvent of formula (I):
R¹ is linear or branched C4;
R² is propyl; and
R³ is hydrogen.

13. The cleaning product according to claim 1, wherein in the glycol ether solvent of formula (II):
R⁴ is C1;
R⁵ is propyl; and
R⁶ is hydrogen.

14. The cleaning product according to claim 13, wherein in the glycol ether solvent of formula (II):
R⁴ is methyl;
R⁵ is isopropyl; and
R⁶ is hydrogen

15. The cleaning product according to claim 1, wherein the composition comprises from about 2.0% to about 10.0% by weight of the total composition of the glycol ether solvents.

16. The cleaning product according to claim 1, wherein the composition comprises the glycol ether solvent of formula (I) and the glycol ether solvent of formula (II) in a weight ratio of from about 1:1 to about 2.25:1.

17. The cleaning product according to claim 16, wherein the composition comprises the glycol ether solvent of formula (I) and the glycol ether solvent of formula (II) in a weight ratio of from about 1:25 to about 2.0:1.

18. The cleaning product according to claim 1, wherein the surfactant system and the organic solvent are present in a weight ratio of from about 3:1 to about 1:3.

19. The cleaning product according to claim 1, wherein the pH of the composition is greater than or equal to about 6 as measured neat at about 20° C.

20. The cleaning product according to claim 1, wherein the composition comprises perfume, wherein the perfume comprises perfume ingredients selected from: essential oils, floral extracts, perfume esters, perfume aldehydes, perfume ketones, and mixtures thereof.
